(19) United States
(12) Patent Application Publication
(10) Pub. No.: US 2023/0130886 A1
(43) Pub. Date: Apr. 27, 2023

(54) METHOD AND SYSTEM FOR DIFFERENTIATING BETWEEN APPLICATION AND INFRASTRUCTURE ISSUES

(71) Applicant: Microsoft Technology Licensing, LLC, Redmond, WA (US)

(72) Inventors: Gal TAMIR, Avichayil (IL); Rachel LEMBERG, Herzliya (IL); Yaniv LAVI, Tel Aviv-Yafo, WA (US)

(21) Appl. No.: 17/508,701

(22) Filed: Oct. 22, 2021

(51) Int. Cl. G06F 11/36; G06F 8/41

(52) U.S. Cl. CPC G06F 11/3604; G06F 8/433; G06F 11/3664; G06F 11/3636

(57) ABSTRACT

Example aspects include techniques for detecting, for one or more instances of a dependency call from a service to a dependency in the cloud computing platform, the one or more instances of the dependency call having a common set of dependency call inputs, that a value of a dependency call performance metric of the dependency call is outside of a threshold range, providing, to a machine learning (ML) model and based on detecting that the value is outside of the threshold range, the common set of dependency call inputs for the one or more instances of the dependency call, obtaining, from the ML model and based on the common set of dependency call inputs, an expected value for the dependency call performance metric, and determining, based on comparing the value to the expected value, the entity causing the value to be outside of the threshold range.

### BACKGROUND

A cloud computing environment may provide one or more resources as a service to customers over a network. In some deployments, a cloud computing environment can implement a multi-tenant architecture that employs a shared set of resources to provide a service to the customers. As an example, a database as a service (DaaS) may provide database functionalities via a cloud computing environment to allow customers to make relational queries using resources shared amongst the customers. A given service may have one or more dependencies, also referred to herein generally as infrastructure, on which the service depends for operation, where the service can query the dependency as part of its functionality. The service can be monitored as it executes to verify health of the service and/or corresponding system. When an issue occurs on the service, it is not immediately apparent whether the issue is caused due to some change or failure in the service or due to some change or failure in the infrastructure. Without this distinction, tracking down a cause of issue reporting may be burdensome for support personnel.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In an aspect, a computer-implemented method for determining an entity causing an issue in a cloud computing platform may include detecting, for one or more instances of a dependency call from a service to a dependency in the cloud computing platform, the one or more instances of the dependency call having a common set of dependency call inputs, that a value of a dependency call performance metric of the dependency call is outside of a threshold range, providing, to a machine learning (ML) model and based on detecting that the value is outside of the threshold range, the common set of dependency call inputs for the one or more instances of the dependency call, obtaining, from the ML model and based on the common set of dependency call inputs, an expected value for the dependency call performance metric, and determining, based on comparing the value to the expected value, the entity causing the value to be outside of the threshold range.

In another aspect, a device may include a memory storing instructions, and at least one processor coupled to the memory. The at least one processor may be configured to execute the instructions to detect, for one or more instances of a dependency call from a service to a dependency in the cloud computing platform, the one or more instances of the dependency call having a common set of dependency call inputs, that a value of a dependency call performance metric of the dependency call is outside of a threshold range, provide, to a ML model and based on detecting that the value is outside of the threshold range, the common set of dependency call inputs for the one or more instances of the dependency call, obtain, from the ML model and based on the common set of dependency call inputs, an expected value for the dependency call performance metric, and determine, based on comparing the value to the expected value, the entity causing the value to be outside of the threshold range.

In another aspect, an example computer-readable medium storing instructions for performing the methods described herein and an example apparatus including means of performing operations of the methods described herein are also disclosed.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example of a cloud computing system, in accordance with some aspects of the present disclosure

FIG. 2 is a diagram showing an example of a machine learning (ML) model, in accordance with some aspects of the present disclosure.

FIG. 3 is a flow diagram illustrating an example of a method for determining a cause of an issue as being a service or a dependency, in accordance with some aspects of the present disclosure.

FIG. 4 is a flow diagram illustrating an example of a method for determining a cause of an issue as being a service or a dependency, in accordance with some aspects of the present disclosure.

FIG. 5 is a block diagram illustrating an example of a hardware implementation for a cloud computing device(s), in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for inferring a cause of an issue (e.g., a reported issue) as being a service or a dependency of the service. As described herein, a service can include a process that executes via a cloud computing environment to provide a function to one or more users. A dependency of the service can include another service or resource in the cloud computing environment that the service can access in providing the functionality. In one specific example, the service can access a database or corresponding database table as a dependency. In an example, a service can initiate a dependency call to the dependency to obtain data therefrom, whether the dependency is another process, database, etc., and the dependency call can include a set of parameters that are provided by the service in executing the dependency call. For example, the dependency call can include a query (e.g., a query on a database table or other construct), a function call, or other call, which can be to the dependency as a web service (e.g., a hypertext transfer protocol (HTTP) call), a queue, or event hub, etc. In one specific example, the service can call the dependency via an application programming interface (API) provided by or for the dependency. In an example, queries between services and dependencies can have, or develop over time, an expected dependency call performance metric, such as an expected dependency call execution time, an expected number of success or failure results, etc. A variance of a dependency call performance metric outside of a threshold range (e.g., a range of statistical significance) may indicate an issue in the dependency.

In accordance with aspects described herein, a cause determining module can be configured to infer, using a machine learning (ML) model, the cause of an issue as being the service or the dependency. For example, the ML model can be trained on inputs of previous queries between the service and the dependency including the set of dependency call parameters and the resulting dependency call performance metric. When a potential issue is detected in one or more queries, the ML model can be used to determine whether the dependency call performance metric of the one or more queries is within an expected value or range of values. If the dependency call performance metric is not within the expected value or range of values, this can indicate the cause of the issue as being the dependency, whereas if the dependency call performance metric is within the expected value or range of values, this can indicate the cause of the issue as being the service.

Providing automated cause determining, in this regard, can allow for more intuitive issue reporting by forwarding information of the issue to the correct support personnel (e.g., the support personnel for the service or the support personnel for the dependency). This may mitigate unnecessary issue investigation by support personnel for the entity not determined to be causing the issue.

### Illustrative Environment

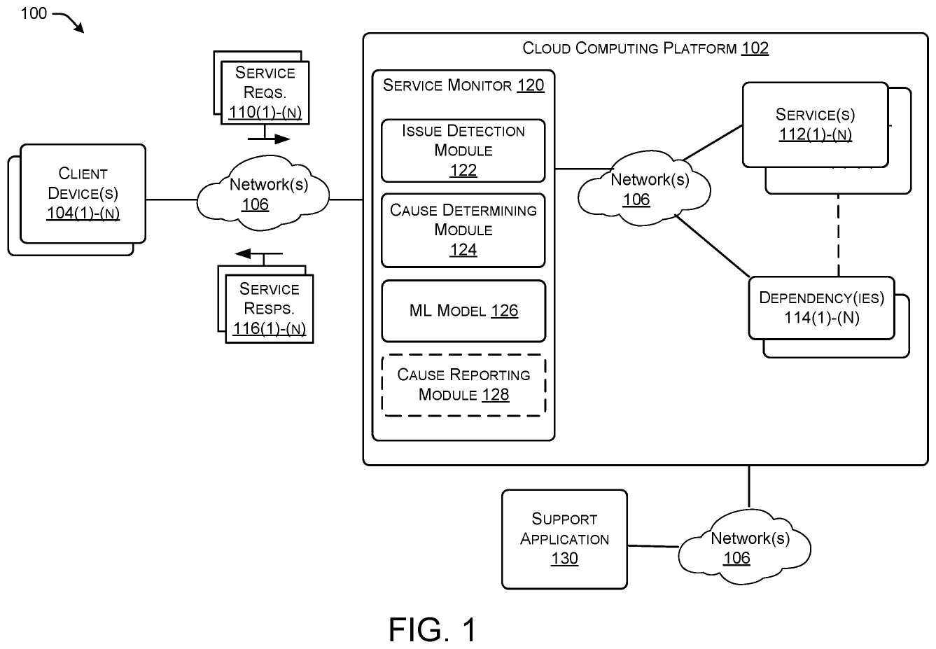

FIG. 1 is a diagram showing an example of a cloud computing system 100, in accordance with some aspects of the present disclosure.

As illustrated in FIG. 1, the cloud computing system 100 may include a cloud computing platform 102, and a plurality of client devices 104(1)-(n). The cloud computing platform 102 may provide the client device(s) 104(1)-(n) with distributed storage and access to software, services, files, and/or data via one or more network(s) 106. The network(s) 106 may include any one or combination of multiple different types of networks, such as cellular networks, wireless networks, local area networks (LANs), wide area networks (WANs), personal area networks (PANs), the Internet, or any other type of network configured to communicate information between computing devices (e.g., the cloud computing platform 102, and the client device(s) 104(1)-(n)). Some examples of the client device(s) 104(1)-(n) include computing devices, smartphone devices, Internet of Things (IoT) devices, drones, robots, process automation equipment, sensors, control devices, vehicles, transportation equipment, tactile interaction equipment, virtual and augmented reality (VR and AR) devices, industrial machines, virtual machines, etc. Further, in some aspects, a client device 104 may include one or more applications configured to interface with the cloud computing platform 102 and/or one or more cloud applications deployed on the cloud computing platform 102. The client device(s) 104(1)-(n) may be associated with customers (i.e., tenants) of the operator of the cloud computing platform 102 or end-users that are subscribers to services and/or applications of the customers that are hosted on the cloud computing platform 102 and provided by the customers to the end users via the cloud computing platform 102.

As illustrated in FIG. 1, the client device(s) 104(1)-(n) may transmit service requests 110(1)-(n) to one or more service(s) 112(1)-(n) provided by the cloud computing platform 102. Some examples of a service 112 include infrastructure as a service (IaaS), platform as a service (PaaS), software as a service (SaaS), search engine as a service (SEaaS), database as a service (DaaS), storage as a service (STaaS), security as a service (SECaaS), big data as a service (BDaaS), monitoring as a service (MaaS), logging as a service (LaaS), internet of things as a service (IOTaaS), identity as a service (IDaaS), analytics as a service (AaaS), function as a service (FaaS), and/or coding as a service (CaaS). Further, for example, each of the one or more service(s) 112(1)-(n) may have one or more dependency(ies) 114(1)-(n) on which the service depends for providing corresponding functionality. The one or more dependency(ies) 114(1)-(n) may also include a service, which may be one or more of an IaaS, PaaS, SaaS, SEaaS, DaaS, STaas, SECaaS, BDaaS, MaaS, LaaS, IOTaaS, IDaaS, AaaS, FaaS, CaaS, or other services. In addition, in an example, multiple services may have one or more common dependencies.

As described in detail herein, the cloud computing platform 102 may include a service monitor 120 for monitoring one or more of the service(s) 112(1)-(n) during execution to detect possible issues. For example, the issues may include incidents observed from an incident report or for reporting to the incident report or other log of issues. Though shown as a separate entity in the cloud computing platform 102, in some examples the service monitor 120 may be part of a corresponding service, may execute on a computing device of the corresponding service, may execute on a dependency, may execute on a computing device of the dependency, etc. In an example, service monitor 120 can report issues to a support application 130 by publishing events, which may include issues, to the support application 130, publishing events to a log that is being monitored by the support application 130, etc. In an example, support personnel can execute the support application 130 to be notified of issues on one or more of the service(s) 112(1)-(n), dependency(ies) 114(1)-(n), etc.

In particular, the service monitor 120 may be configured to infer or determine a cause of a detected issue as being a service or dependency. Service monitor 120 may include an issue detection module 122 configured to detect an issue occurring on a service 112 of the one or more service(s) 112(1)-(n), a cause determining module 124 configured to determine or infer a cause of the issue as being the corresponding service 112 or one or more dependency(ies) 114(1)-(n) on which the service 112 depends, an ML model 126 configured to be trained based on queries between the service 112 and the one or more dependency(ies) 114(1)-(n) for comparing dependency call performance metrics for determining the cause of the issue, and/or an optional cause reporting module 128 configured for reporting the cause of the issue.

In an example, service monitor 120 can train the ML model 126 with sets of dependency call parameters for queries between a given service 112 and one or more dependency(ies) 114(1)-(n) and corresponding dependency call performance metrics. In this regard, when an issue is detected, cause determining module 124 can employ the ML model 126 to determine expected dependency call performance metrics for a set of dependency call parameters associated with a dependency call for which the issue is detected. In an example, ML model 126 can provide an output of expected dependency call performance metrics for the dependency call. In this example, cause determining module 124 can determine the cause of the issue based on whether the dependency call performance metrics for the dependency call are within a threshold tolerance of expected dependency call performance metrics for the dependency call or not. In another example, based on the set of dependency call parameters and the dependency call performance metric of the dependency call for which the issue is detected, ML model 126 can provide a binary output of whether the dependency call performance metrics are within a threshold tolerance or not. In any case, cause determining module 124 can determine whether the cause of the issue is the service 112 or a dependency 114 of the one or more dependency(ies) 114(1)-(n) based on the output of the ML model 126.

In one example, the ML model 126 can be trained at a dependency 114 of the dependency(ies) 114(1)-(n) based on queries from one or more service(s) 112(1)-(n) to include the sets of dependency call parameters and corresponding dependency call performance metrics. In this example, the dependency 114 may provide the ML model 126 to a service monitor 120 for use in determining whether the dependency 114 is the cause of an issue. In this example, the dependency 114 may have more data regarding the dependency call than a given service 112 of the multiple services 112(1)-(n), as the dependency 114 can be used by multiple services 112(1)-(n). In an example, the service monitor 120 can access the ML model 126 provided by the dependency 114 via API. In addition, as described for example, a service 112 of the service(s) 112(1)-(n) can similarly train the ML model 126 for the service 112 and its one or more dependency(ies) 114(1)-(n). Where the service monitor 120 executes separately from the service 112 (e.g., on a different computing device or otherwise without access to the same memory), service monitor 120 can request the ML model 126 from the service 112 via API.

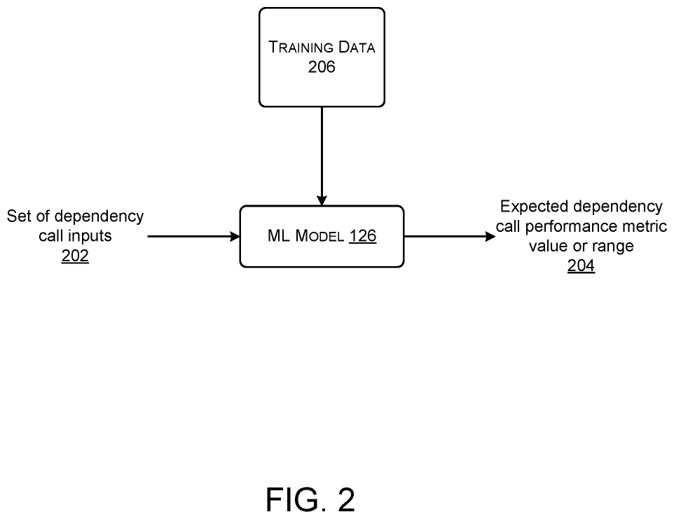

FIG. 2 is a diagram showing an example of a ML model 126, in accordance with some aspects of the present disclosure.

ML model 126 can be trained and configured to receive a set of dependency call inputs 202 from a dependency call between a service and a dependency, and output an expected dependency call performance metric value or range of values 204. For example, ML model 126 can be trained using training data 206, which can include data of previous (e.g., historical) queries between the service and the dependency. The training data 206 can include sets of dependency call inputs and corresponding dependency call performance metrics for multiple instances of the dependency call. For example, different sets of dependency call inputs can result in different dependency call performance metrics. In an example, one set of dependency call input values may take longer to process and may result in a longer dependency call execution time, a lower success rate, etc. than another set of dependency call input values. In this regard, the ML model 126 can be trained to associate each set of dependency call input values with an expected dependency call performance metric value or range of values. In other examples, as described above and further herein, the ML model 126 may also receive, as input, the dependency call performance metric value corresponding to the set of dependency call inputs 202. In this example, the ML model 126 may output a binary indicator of whether or not the dependency call performance metric value is within the expected value or range of values.

### Example Processes

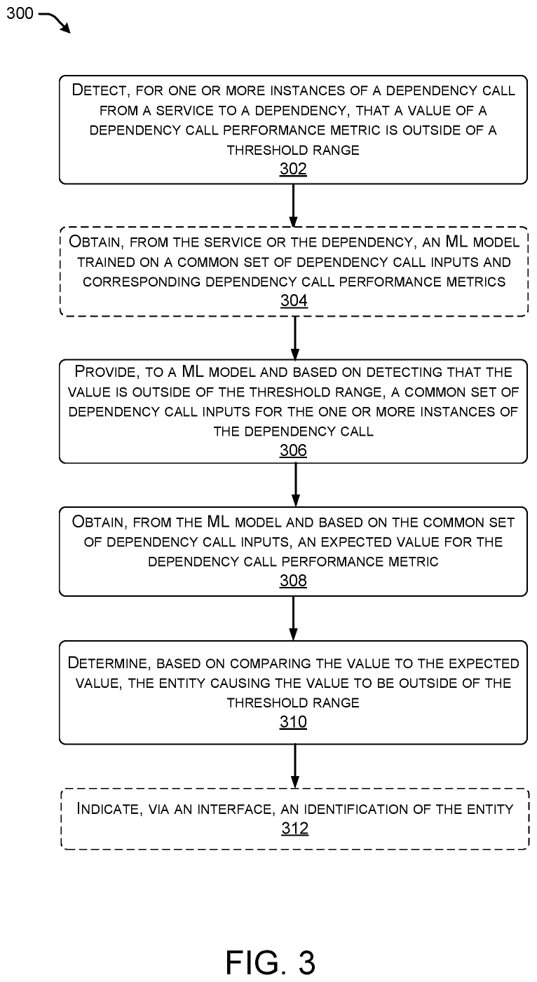

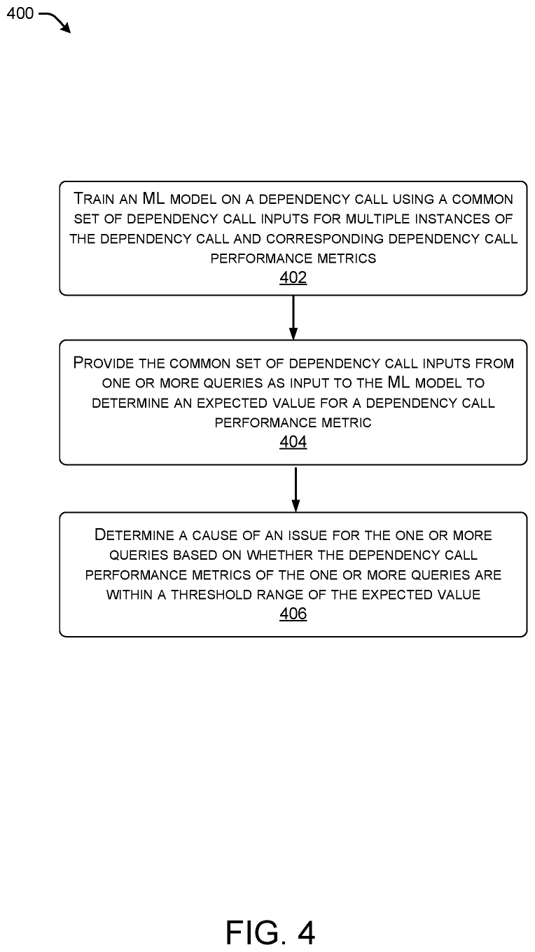

The processes described in FIGS. 3-4 below are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. The operations described herein may, but need not, be implemented using the service monitor 120. By way of example, the methods 200 and 300 are described in the context of FIGS. 1, 2, and 5. For example, the operations may be performed by one or more of the service monitor 120, issue detection module 122, cause determining module 124, ML model 126, cause reporting module 128, etc.

FIG. 3 is a flow diagram illustrating an example of a method 300 for determining a cause of an issue as being a service or a dependency, in accordance with some aspects of the present disclosure.

At block 302, the method 300 may include detecting, for one or more instances of a dependency call from a service to a dependency, that a value of a dependency call performance metric is outside of a threshold range. For example, issue detection module 122, e.g., in conjunction with a processor 502, memory 504, cloud computing device 500, cloud computing platform 102, service monitor 120, can detect, for one or more instances of the dependency call from the service (e.g., a service 112 of one or more service(s) 112(1)-(n)) to a dependency (e.g., a dependency 114 of one or more dependency(ies) 114(1)-(n)), that a value of a dependency call performance metric is outside of a threshold range. As described, the dependency call performance metrics may include a dependency call execute time, a dependency call success or failure rate, etc. In an example, during execution, the service 112 may send multiple queries to the dependency 114 to provide one or more functions of the service 112. The queries may use the same, similar, or different dependency call input parameter values (also referred to herein as dependency call inputs). A given dependency call and/or a given set of dependency call inputs may typically have a similar dependency call performance metric (e.g., a dependency call performance metric that is within a threshold range or statistical significance).

In an example, when the dependency call performance metric strays from the threshold range, or does so (e.g., is outside the threshold range) for a threshold number of consecutive queries within a threshold time window, this may indicate that an issue is occurring with the dependency call, where the cause may be the service 112 or the dependency 114, as described. Accordingly, for example, issue detection module 122 can detect an issue with the dependency call when the dependency call performance metric strays from the threshold range, or does so for a threshold number of consecutive queries. In an example, the threshold range can be selected to be of substantially any value that results in a desired level of detecting actual issues versus false positive detection. In one example, issue detection module 122 can similarly use an ML model to determine the expected dependency call performance metric, to determine when the dependency call performance metric is outside of the threshold range or otherwise indicative of an issue with the dependency call, service 112, or dependency 114, etc., though not shown and described for ease of explanation.

At block 304, the method 300 may optionally include obtaining, from the service 112 or dependency 114, an ML model trained on a common set of dependency call inputs and corresponding dependency call performance metrics. For example, cause determining module 124, e.g., in conjunction with a processor 502, memory 504, cloud computing device 500, cloud computing platform 102, service monitor 120, etc., can obtain, from the service (e.g., a service 112 of one or more service(s) 112(1)-(n)) or the dependency (e.g., a dependency 114 of one or more dependency(ies) 114(1)-(n)), the ML model (e.g., ML model 126) trained on a common set of dependency call inputs and corresponding dependency call performance metrics. In an example, the ML model 126 can be trained at the service 112 or dependency 114, as described, and in these examples, cause determining module 124 can request the model from the service 112 or dependency 114, or can otherwise access the model at the service 112 or dependency 114 (e.g., via an API) to provide inputs of the one or more instances of the dependency call and receive an output of the ML model. In other examples, the service monitor 120 can train and/or store the ML model 126.

At block 306, the method 300 may include providing, to an ML model and based on detecting that the value is outside of the threshold range, a common set of dependency call inputs for the one or more instances of the dependency call. For example, cause determining module 124, e.g., in conjunction with a processor 502, memory 504, cloud computing device 500, cloud computing platform 102, service monitor 120, etc., can provide, to the ML model (e.g., ML model 126 or an ML model otherwise stored by or accessible from the service 112 or dependency 114) and based on detecting that the value is outside of the threshold range, the common set of dependency call inputs for the one or more instances of the dependency call. As described, for example, the one or more instances of the dependency call that related to detecting the issue by issue detection module 122 can have a set of common dependency call inputs, and a resulting dependency call performance metric may be outside of the threshold range. In this example, cause determining module 124 can input the set of common dependency call inputs into the ML model 126 to determine an output indicating whether the cause of the issue is the service 112 or the dependency 114. For example, the output from the ML model 126 can include an expected value for the dependency call performance metric, an indication of whether the dependency call performance metric for the one or more instances of the dependency call is outside of an expected range, a binary indication of the cause of the issue, etc.

At block 308, the method 300 may include obtaining, from the ML model and based on the common set of dependency call inputs, an expected value for the dependency call performance metric. For example, cause determining module 124, e.g., in conjunction with a processor 502, memory 504, cloud computing device 500, cloud computing platform 102, service monitor 120, etc., can obtain, from (or by) the ML model 126 and based on the common set of dependency call inputs, the expected value for the dependency call performance metric. As described, this can be performed within the model or separately by the cause determining module 124 (e.g., based on whether the ML model 126 outputs the metric or a decision as to whether the metric is within an expected value or range).

At block 310, the method 300 may include determining, based on comparing the value to the expected value, the entity causing the value to be outside of the threshold range. For example, cause determining module 124, e.g., in conjunction with a processor 502, memory 504, cloud computing device 500, cloud computing platform 102, service monitor 120, etc., can determine, based on comparing the value to the expected value, the entity (e.g., the service 112 or the dependency 114) causing the value to be outside of the threshold range. In one example, cause determining module 124 can determine whether a difference between the value and the expected value achieves a threshold or is less than the threshold. For example, where cause determining module 124 determines the value to be outside of the expected value or range of values for the common set of dependency call parameters (e.g., the difference between the value and the expected value achieves the threshold), this may indicate the dependency 114 as the cause of the issue (e.g., the cause of the value being outside the threshold range as detected by the issue detection module 122). In another example, where cause determining module 124 determines the value to be within the expected value or range of values for the common set of dependency call parameters (e.g., the difference between the value and the expected value is less than the threshold), this may indicate the service 112 as the cause of the issue (e.g., the cause of the value being outside the threshold range as detected by the issue detection module 122).

At block 312, the method 300 may optionally include indicating, via an interface, an identification of the entity. For example, cause reporting module 128, e.g., in conjunction with a processor 502, memory 504, cloud computing device 500, cloud computing platform 102, service monitor 120, etc., can indicate, via an interface, an identification of the entity. As described, for example, various indications of the identification of the entity can be used. In one example, cause reporting module 128 can indicate the identification of the entity to a support application 130, which can include publishing the identification of the entity in an event to which the support application 130 subscribes, calling a function of the support application 130 to report the identification of the entity, publishing the identification of the entity in a log file, which in some examples the support application 130 may monitor, etc. For example, there can be a first support application for the service 112 and a second support application for the dependency 114, and cause reporting module 128 can report the identification of the entity to either the first support application or the second support application, or both, based on whether the entity causing the issue is determined to be the service 112 or the dependency 114. In another example, the service monitor 120 may include an interface to which the cause reporting module 128 can report the identification of the entity as the cause of an issue being viewed on via the service monitor 120, etc. In another example, cause reporting module 128 can report the identification of the entity in a log file, as described, or based on a request from another application or service, etc. In yet another example, cause reporting module 128 can report the identification of the entity in generating a support ticket in an automated ticketing system that identifies the entity as causing the value to be outside of the threshold range. For example, the automated ticketing system can execute to notify support personnel of issues of the service 112 or of the dependency 114. In one example, the service 112 and dependency 114 can use different (or different instances of) the automated ticketing system, and cause reporting module 128 can route the support ticket to the appropriate automated ticketing system based on identifying which entity is causing the issue, as described above. In any case, further investigation of the issue can be eased by the reporting of the entity, such to narrow investigation to that entity (e.g., the service 112 or the dependency 114) and not necessary the other entity.

FIG. 4 is a flow diagram illustrating an example of a method 400 for determining a cause of an issue as being a service or a dependency, in accordance with some aspects of the present disclosure.

At block 402, the method 400 may include training a ML model on a dependency call using a common set of dependency call inputs for multiple instances of the dependency call and corresponding dependency call performance metrics. For example, service monitor 120, service 112, dependency 114, or another entity that stores ML model 126, e.g., in conjunction with a processor 502, memory 504, cloud computing device 500, cloud computing platform 102, service monitor 120, etc., can train the ML model 126 on the dependency call using the common set of dependency call inputs for multiple instances of the dependency call (e.g., previous instances of the dependency call that were previously executed between the service and dependency) and corresponding dependency call performance metrics. This can enable the ML model 126 to associate the common set of dependency call inputs with an expected value or range of values for the dependency call performance metric of a corresponding dependency call.

At block 404, the method 400 may include providing the common set of dependency call inputs from one or more queries as input to the ML model to determine the expected value for a dependency call performance metric. For example, service monitor 120, service 112, dependency 114, or another entity that stores or can otherwise access the ML model 126, e.g., in conjunction with a processor 502, memory 504, cloud computing device 500, cloud computing platform 102, service monitor 120, etc., can provide the common set of dependency call inputs from one or more queries (e.g., common values for the dependency call inputs that were used for the one or more queries) as input to the ML model to determine the expected value for a dependency call performance metric. The queries can correspond to queries determined to indicate a possible issue at a service 112 or dependency 114 of the dependency call, as described above, and may have the same common set of dependency call input values.

At block 406, the method 400 may include determining a cause of an issue for the one or more queries based on whether the dependency call performance metrics of the one or more queries are within a threshold range of the expected value. For example, service monitor 120, service 112, dependency 114, or another entity that stores or can otherwise access the ML model 126, e.g., in conjunction with a processor 502, memory 504, cloud computing device 500, cloud computing platform 102, service monitor 120, etc., can determine the cause of the issue for the one or more queries based on whether the dependency call performance metrics of the one or more queries are within a threshold range of the expected value. As described, this may be a binary determination or indication of the issue based on whether or not the dependency call performance metrics of the one or more queries (or a threshold number of the dependency call performance metrics) are within a threshold range of the expected value. As described, the dependency call performance metrics for a specific instance of a dependency call may include a dependency call execution time, whether the dependency call succeeded or not, etc. In another example, dependency call performance metrics of multiple instances of a dependency call can be considered together and used in determining the cause of the issue. For example, the dependency call performance metrics compared to the expected value may include an average dependency call execution time of the multiple instances of the dependency call, a dependency call success rate of the multiple instances of the dependency call, etc.

### Illustrative Computing Device

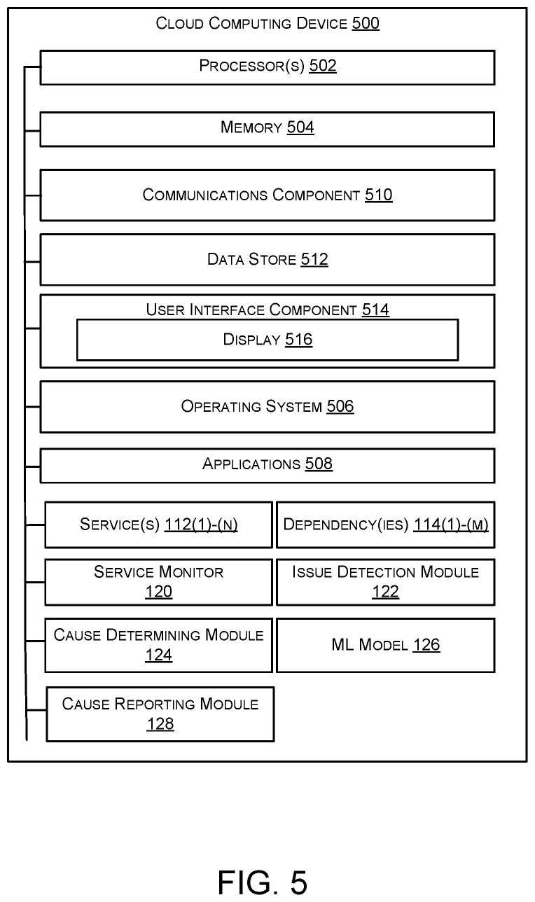

Referring now to FIG. 5, an example of cloud computing device 500 (e.g., cloud computing platform 102) is provided. In one example, the cloud computing device 500 includes the processor(s) 502 for carrying out processing functions associated with one or more of components and functions described herein. The processor(s) 502 can include a single or set of multiple processors or multi-core processors. Moreover, the processor(s) 502 may be implemented as an integrated processing system and/or a distributed processing system. In an example, the processor(s) 502 include any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor(s) 502 may include other processing components such as one or more arithmetic logic units (ALUs), registers, or control units.

In an example, the cloud computing device 500 also includes the memory 504 for storing instructions executable by the processor(s) 502 for carrying out the functions described herein. The memory 504 may be configured for storing data and/or computer-executable instructions defining and/or associated with the operating system 506, the service(s) 112(1)-(n), dependency(ies) 114(1)-(n), the service monitor 120, issue detection module 122, cause determining module 124, ML model 126, cause reporting module 128, and the processor 502 may execute the operating system 506, the service(s) 112(1)-(n), dependency(ies) 114(1)-(n), the service monitor 120, issue detection module 122, cause determining module 124, ML model 126, and/or cause reporting module 128. An example of memory 504 may include a type of memory usable by a computer, such as random access memory (RAM), read only memory (ROM), tapes, magnetic discs, optical discs, volatile memory, non-volatile memory, and any combination thereof. In an example, the memory 504 may store local versions of applications being executed by processor(s) 502.

The example cloud computing device 500 also includes a communications component 510 that provides for establishing and maintaining communications with one or more parties utilizing hardware, software, and services as described herein. The communications component 510 may carry communications between components on the cloud computing device 500, as well as between the cloud computing device 500 and external devices, such as devices located across a communications network and/or devices serially or locally connected to the cloud computing device 500. For example, the communications component 510 may include one or more buses, and may further include transmit chain components and receive chain components associated with a transmitter and receiver, respectively, operable for interfacing with external devices. In an implementation, for example, the communications component 510 may include a connection to communicatively couple the client device(s) 104(1)-(N) to the processor(s) 502.

The example cloud computing device 500 also includes a data store 512, which may be any suitable combination of hardware and/or software, that provides for mass storage of information, databases, and programs employed in connection with implementations described herein. For example, the data store 512 may be a data repository for the operating system 506 and/or the applications 508.

The example cloud computing device 500 also includes a user interface component 514 operable to receive inputs from a user of the cloud computing device 500 and further operable to generate outputs for presentation to the user. The user interface component 514 may include one or more input devices, including a keyboard, a number pad, a mouse, a touch-sensitive display (e.g., display 516), a digitizer, a navigation key, a function key, a microphone, a voice recognition component, any other mechanism capable of receiving an input from a user, or any combination thereof. Further, the user interface component 514 may include one or more output devices, including a display (e.g., display 516), a speaker, a haptic feedback mechanism, a printer, any other mechanism capable of presenting an output to a user, or any combination thereof.

In an implementation, the user interface component 514 may transmit and/or receive messages corresponding to the operation of the operating system 506 and/or the applications 508. In addition, the processor(s) 502 executes the operating system 506 and/or the applications 508, and the memory 504 or the data store 512 may store them.

Further, one or more of the subcomponents of the service(s) 112(1)-(n), dependency(ies) 114(1)-(n), the service monitor 120, issue detection module 122, cause determining module 124, ML model 126, cause reporting module 128, may be implemented in one or more of the processor(s) 502, the applications 508, the operating system 506, and/or the user interface component 514 such that the subcomponents of the service(s) 112(1)-(n), dependency(ies) 114(1)-(n), the service monitor 120, issue detection module 122, cause determining module 124, ML model 126, cause reporting module 128, are spread out between the components/subcomponents of the cloud computing device 500.

In closing, although the various embodiments have been described in language specific to structural features and/or methodological acts, it is to be understood that the subject matter defined in the appended representations is not necessary limited to the specific features or acts described. Rather, the specific features and acts are disclosed as example forms of implementing the claimed subject matter.

What is claimed is:

1. A computer-implemented method for determining an entity causing an issue in a cloud computing platform, comprising:
detecting, for an instance of a dependency call from a service to a dependency in the cloud computing platform, that a value of a dependency call performance metric of the dependency call is outside of a threshold range, the instance of the dependency call having a common set of dependency call inputs;
providing, to a machine learning (ML) model and based on detecting that the value is outside of the threshold range, the common set of dependency call inputs for the instance of the dependency call;
obtaining, from the ML model and based on the common set of dependency call inputs, an expected value for the dependency call performance metric;
determining, based on comparing the value to the expected value, the entity causing the value to be outside of the threshold range as the entity causing the issue; and
indicating, via an interface, the entity.

2. The computer-implemented method of claim 1, wherein detecting that the value of the dependency call performance metric is outside of the threshold range includes detecting that the dependency call performance metric for multiple instances of the dependency call is within a threshold time window each have a corresponding value for the dependency call performance metric that is outside of the threshold range.

3. The computer-implemented method of claim 1, further comprising training the ML model using multiple previous instances of the dependency call having the common set of dependency call inputs and corresponding values for the dependency call performance metric to generate the expected value for the dependency call performance metric given the common set of dependency call inputs.

4. The computer-implemented method of claim 1, wherein where comparing the value to the expected value results in a difference that achieves a threshold difference, determining the entity includes determining the dependency as the entity causing the issue.

5. The computer-implemented method of claim 1, wherein where comparing the value to the expected value results in a difference that is less than a threshold difference, determining the entity includes determining the service as the entity causing the issue.

6. The computer-implemented method of claim 1, wherein the dependency call performance metric includes a dependency call execution time.

7. The computer-implemented method of claim 1, wherein the dependency call performance metric includes a dependency call success rate.

8. The computer-implemented method of claim 1, wherein indicating the entity includes generating a support ticket in an automated ticketing system that identifies the entity as causing the issue.

9. A cloud computing device for operating in a cloud computing platform, comprising:
a memory storing instructions; and
a processor coupled to the memory and configured to execute the instructions to:
detect, for an instance of a dependency call from a service to a dependency in the cloud computing platform, that a value of a dependency call performance metric of the dependency call is outside of a threshold range, the instance of the dependency call having a common set of dependency call inputs;
provide, to a machine learning (ML) model and based on detecting that the value is outside of the threshold range, the common set of dependency call inputs for the instance of the dependency call;
obtain, from the ML model and based on the common set of dependency call inputs, an expected value for the dependency call performance metric;
determine, based on comparing the value to the expected value, an entity causing the value to be outside of the threshold range as the entity causing an issue; and
indicate, via an interface, the entity.

10. The cloud computing device of claim 9, wherein the processor is configured to detect that the value of the dependency call performance metric is outside of the threshold range at least in part by detecting that the dependency call performance metric for multiple instances of the dependency call is within a threshold time window each have a corresponding value for the dependency call performance metric that is outside of the threshold range.

11. The cloud computing device of claim 9, wherein the processor is further configured to execute the instructions to train the ML model using multiple previous instances of the dependency call having the common set of dependency call inputs and corresponding values for the dependency call performance metric to generate the expected value for the dependency call performance metric given the common set of dependency call inputs.

12. The cloud computing device of claim 9, wherein where comparing the value to the expected value results in a difference that achieves a threshold difference, the processor is configured to determine the dependency as the entity causing the issue.

13. The cloud computing device of claim 9, wherein where comparing the value to the expected value results in a difference that is less than a threshold difference, the processor is configured to determine the service as the entity causing the issue.

14. The cloud computing device of claim 9, wherein the dependency call performance metric includes a dependency call execution time.

15. The cloud computing device of claim 9, wherein the dependency call performance metric includes a dependency call success rate.

16. The cloud computing device of claim 9, wherein the processor is configured to indicate the entity at least in part by generating a support ticket in an automated ticketing system that identifies the entity as causing the value to be outside of the threshold range.

17. A non-transitory computer-readable device storing instructions thereon that, when executed by a computing device operating in a cloud computing platform, causes the computing device to perform operations comprising:
detecting, for an instance of a dependency call from a service to a dependency in the cloud computing platform, that a value of a dependency call performance metric of the dependency call is outside of a threshold range, the instance of the dependency call having a common set of dependency call inputs;
providing, to a machine learning (ML) model and based on detecting that the value is outside of the threshold range, the common set of dependency call inputs for the instance of the dependency call;
obtaining, from the ML model and based on the common set of dependency call inputs, an expected value for the dependency call performance metric;
determining, based on comparing the value to the expected value, an entity causing the value to be outside of the threshold range as the entity causing an issue; and
indicating, via an interface, the entity.

18. The non-transitory computer-readable device of claim 17, wherein detecting that the value of the dependency call performance metric is outside of the threshold range includes detecting that the dependency call performance metric for multiple instances of the dependency call within a threshold time window each have a corresponding value for the dependency call performance metric that is outside of the threshold range.

19. The non-transitory computer-readable device of claim 17, the operations further comprising training the ML model using multiple previous instances of the dependency call having the common set of dependency call inputs and corresponding values for the dependency call performance metric to generate the expected value for the dependency call performance metric given the common set of dependency call inputs.

20. The non-transitory computer-readable device of claim 17,
wherein where comparing the value to the expected value results in a difference that achieves a threshold difference, determining the entity includes determining the dependency as entity causing the issue, and
wherein where comparing the value to the expected value results in a difference that is less than a threshold difference, determining the entity includes determining the service as the entity causing the issue.
